(19) United States
(12) Patent Application Publication
(10) Pub. No.: US 2010/0120270 A1
(43) Pub. Date: May 13, 2010

(54) TEST SOCKET ASSEMBLY HAVING STACKED INSULATIVE BOARDS

(75) Inventor: MING-YUE CHEN, Tu-Cheng (TW)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION INDUSTRY CO., LTD., Tu-Cheng (TW)

(21) Appl. No.: 12/616,014

(22) Filed: Nov. 10, 2009

(30) Foreign Application Priority Data
Nov. 10, 2008 (TW) 97220126

(51) Int. Cl. H01R 12/00

(52) U.S. Cl. 439/70

(57) ABSTRACT

A socket assembly, for electrically connecting IC package and a printed circuit board, has a base with a cavity, a module received in the cavity of the base, a plurality of helical contacts received in the module and a cover mounted on the base. The module has a positioning board, a retaining board and a plurality of stacked insulative boards disposed between the positioning board and the retaining board. Each insulative board defines a plurality of through holes, which cooperatively define a plurality of separate helical channels to receive the contacts.

### 1. FIELD OF THE INVENTION

The present invention relates to a test socket, and more particularly to a test socket includes an insulative housing configured by a plurality layers of boards with a plurality of contact terminals arranged therein such that the board can be moved horizontally in accordance with the movement of the contact terminals.

### 2. DESCRIPTION OF RELATED ART

Traditional socket assembly, especially testing socket assembly for IC packages, is used for electrically connecting an IC package to a printed circuit board. Such socket assembly usually comprises a unitary base defining a receiving space in a center thereof, two insulative boards mounted within the base under the receiving space, a plurality of contacts retained by the insulative boards and a cover mounted upon the base. The contact has a first contacting portion extending into the receiving space for contacting with an IC package, a middle portion having an arch shape and located in a room defined between the insulative boards in a vertical direction to provide a resilience of the contact and a tail portion for contacting with a printed circuit board.

When the contact is pressed by the IC package, the middle portion is curved and moves in a horizontally direction. A distance between adjacent contacts of above socket assembly is designed with a bigger value to prevent short circuit of adjacent contacts, accordingly, this socket assembly may not adapt to miniaturization of sockets and can not provide a high signal transmission speed.

Hence, an improved socket assembly is required to overcome the above-mentioned disadvantages of the related art.

### SUMMARY OF THE INVENTION

An object of the present invention is to provide a socket assembly having a module configured by a plurality layers of stacked and moveable insulative boards which cooperatively define a plurality of channels therethrough for contacts of the socket assembly.

To achieve the aforementioned object, a socket assembly comprises a base having a cavity, a plurality of contacts and a module receiving the contacts and mounted in the cavity of the base. The module has a plurality layers of stacked insulative boards, each insulative board defines a plurality of through holes, and those through holes are aligned to cooperatively define a plurality of individual channels to receive the contacts.

Other objects, advantages and novel features of the invention will become more apparent from the following detailed description of a preferred embodiment when taken in conjunction with the accompanying drawings.

### BRIEF DESCRIPTION OF THE DRAWINGS

FIG. 1 is an assembled, perspective view of a socket assembly in accordance with a preferred embodiment of present invention;

FIG. 2 is a partially exploded, perspective view of the socket assembly in FIG. 1

FIG. 3 is an exploded, perspective view of the socket assembly;

FIG. 4 is similar with FIG. 3, but taken from another side;

FIG. 5 is a partially assembled, perspective view of the socket assembly;

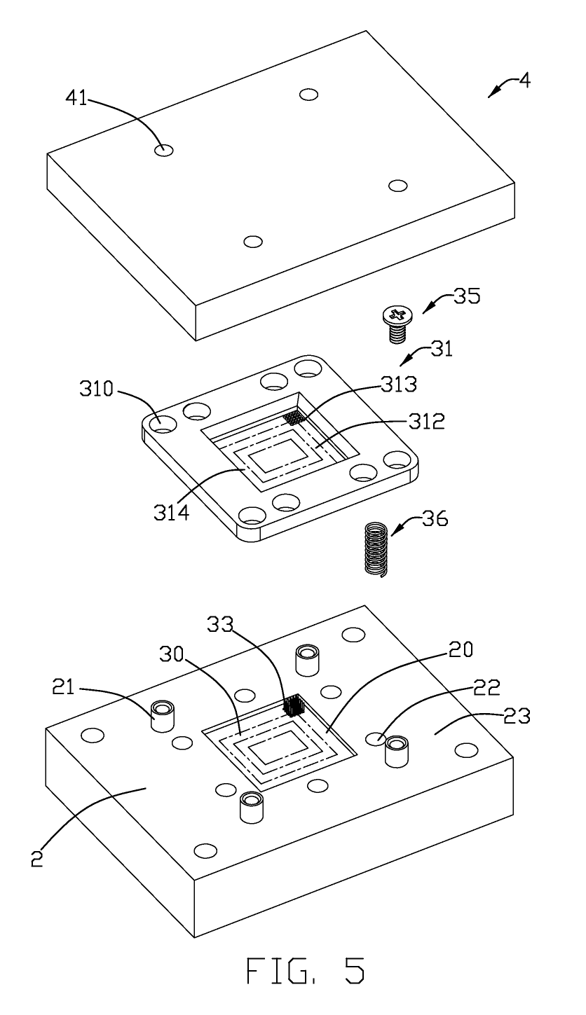

FIG. 6 is a partial sectional view of the socket assembly;

FIG. 7 is a perspective view of the socket assembly in FIG. 6;

FIG. 8 is a perspective view of a module of the socket assembly;

FIG. 9 is a sketch view showing contacts received in the module;

FIG. 10 is similar with FIG. 9, except that the contacts deflect; and

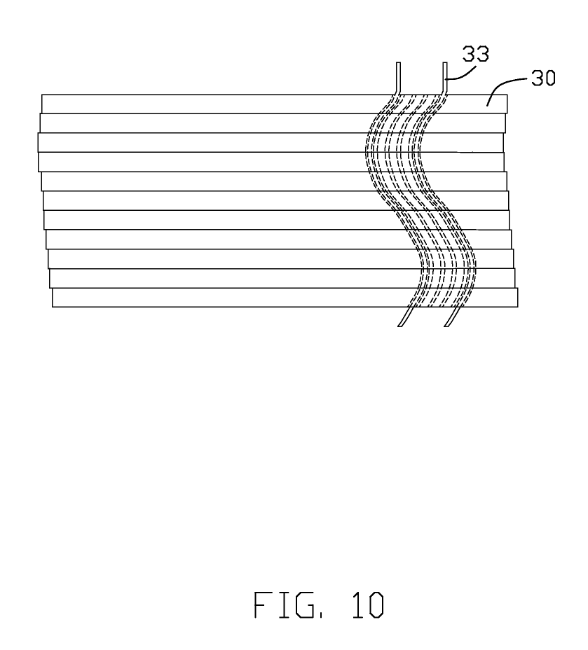

FIG. 11 is a perspective view of a contact of the socket.

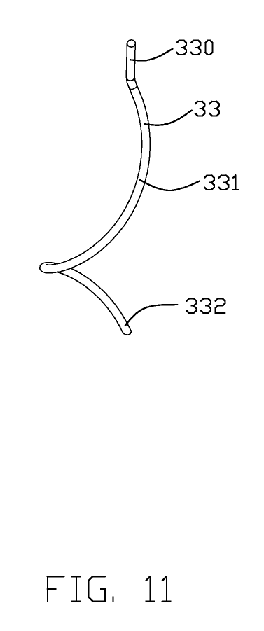

### DETAILED DESCRIPTION OF THE INVENTION

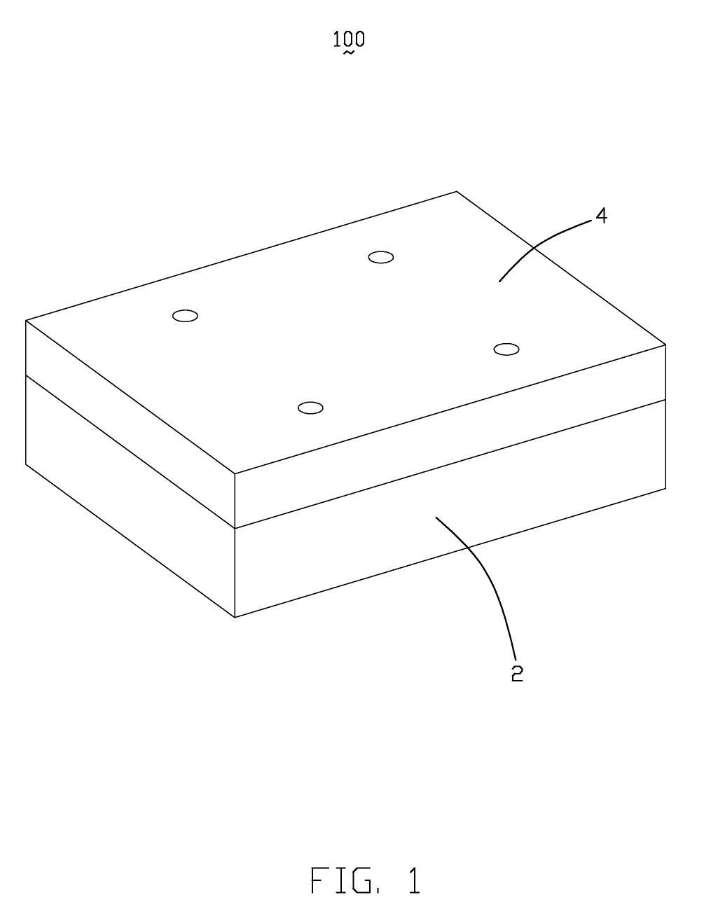

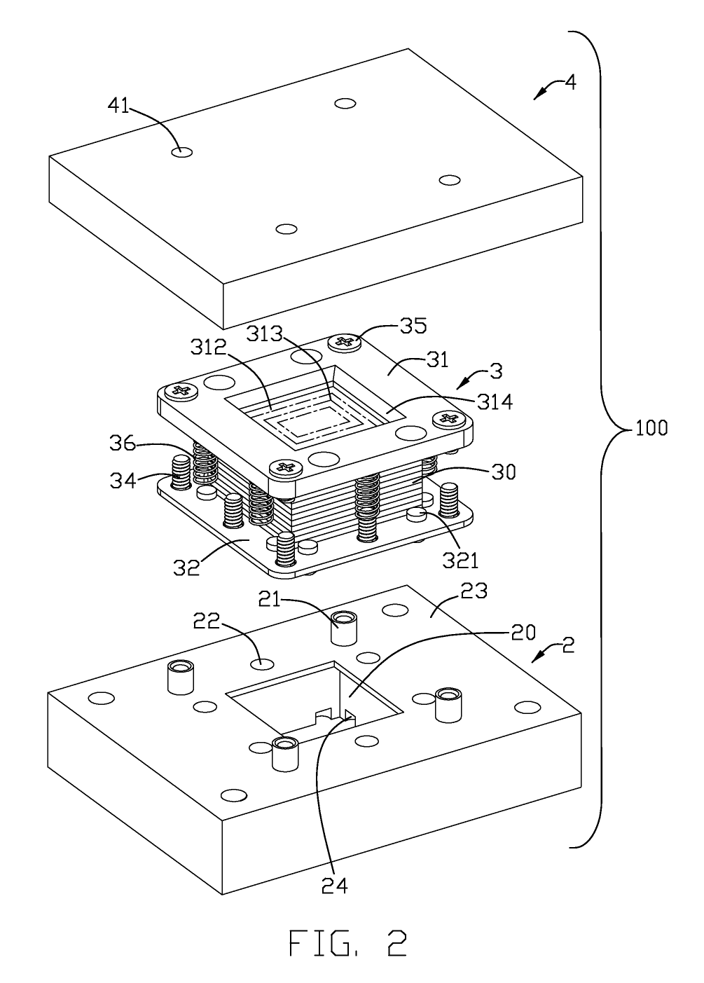

Referring to FIG. 1 to FIG. 2, the socket assembly 100 has a base 2, a module 3, a plurality of contacts 33 and a cover 4 mounted on the base 2.

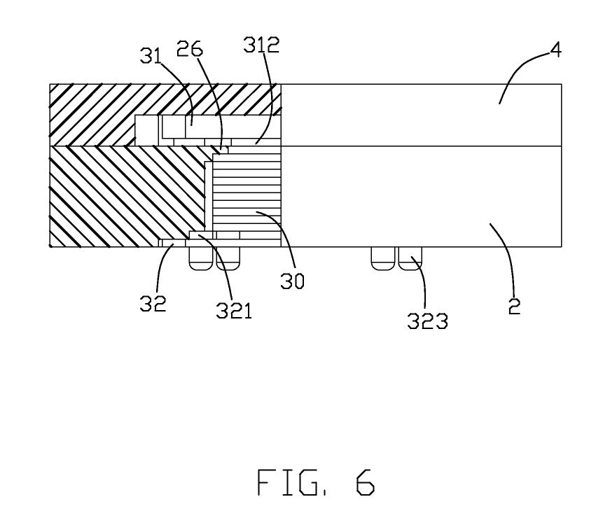

Referring to FIG. 2 to FIG. 4, the base 2 has a rectangular configuration with a top surface 23 and a bottom surface 25 and defines a cavity 20 extending through a center thereof. The base 2 has a flange 26 protruding from a top edge of the cavity 20 toward a center of the cavity 20 to limit an upper insulative board 30 of the module 3 from a top side (referring to FIG. 6). A plurality of linking posts 21 upwardly extend from the top surface 23 and around the cavity 20, and a plurality of recesses 22 are defined between two adjacent linking posts 21 for receiving corresponding springs 36. A plurality of positioning holes 24 are defined on four corners of the cavity 20 and recessed upwardly from a bottom side of the base 2.

The module 3 has a positioning board 31, a retaining board 32 and a plurality of layers of stacked insulative boards 30 disposed between the positioning board 31 and the retaining board 32. The positioning board 31 is assembled on the top surface 23 of the base 2, the retaining board 32 is retained on the bottom surface 25 of the base 2, and the insulative boards 30 are received in the cavity 20 of the base 2 as a whole.

Referring to FIGS. 2-4, the positioning board 31 defines a plurality of holes 310 on four corners thereof and a receiving space 314 in a center thereof. A bottom wall 312 under the receiving space 314 has a plurality of contact passageways 313 for receiving the contacts 33. The positioning board 31 is mounted on the top surface 23 of the base 2 by a plurality of screws 35 passing through the holes 310 of the posting board 31 and engaging with the linking posts 21 of the base 2. The springs 36 are mounted between the recesses 22 of the base 2 and the positioning board 31.

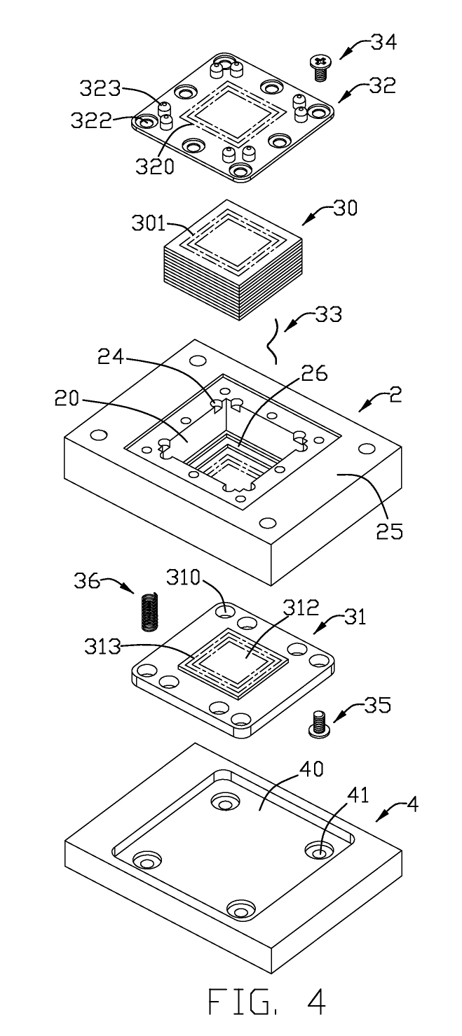

The retaining board 32 has a plurality of contact slots 320 for receiving the contacts 33, and a plurality of retaining posts 321 extending from a top surface thereof for engaging with the positioning holes 24 of the base 2 to limit the insulative boards 30 from a bottom side. Especially referring to FIG. 4, the retaining board 32 has a plurality of retaining legs 323 extending downwardly from a bottom surface thereof to orientate the socket assembly 100 on a printed circuit board (not shown). Four engaging holes 322 are provided on four corners of the retaining board 32. The retaining board 32 is installed to the bottom surface 25 of the base 2 by bolts 34 passing through the engaging holes 322 and engaging with the base 2.

The cover 4 covers the base 2, and defines a recessed portion 40 recessed upwardly from a bottom surface thereof. After the positioning board 31 is located above the base 2, the cover 4 is mounted upon the base 2 by bolts (not shown), which pass through a plurality of mounting holes 41 of the cover 4, then the positioning board 31 is located within the recessed portion 40 of the cover 4.

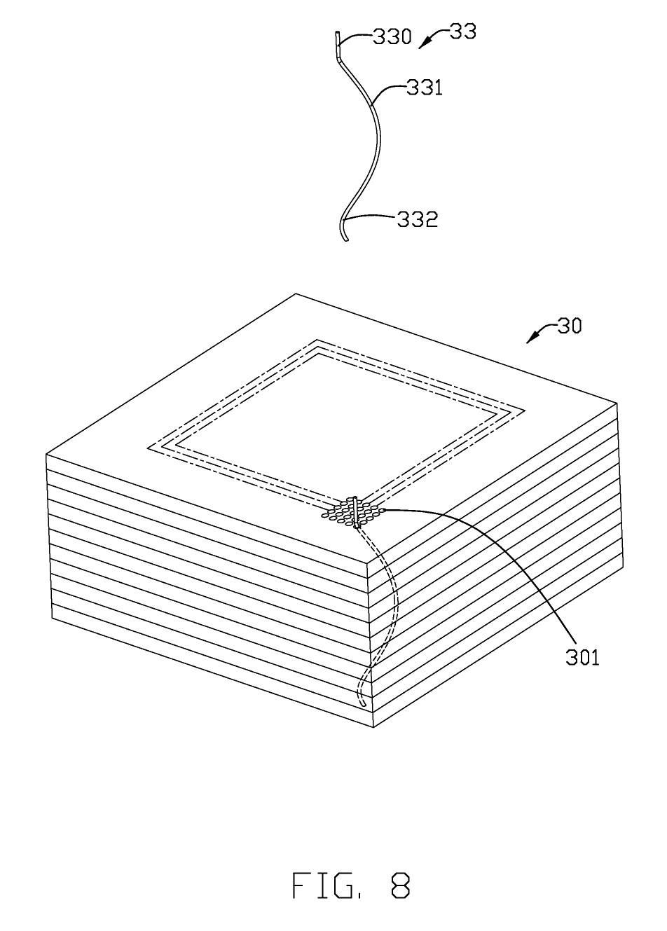

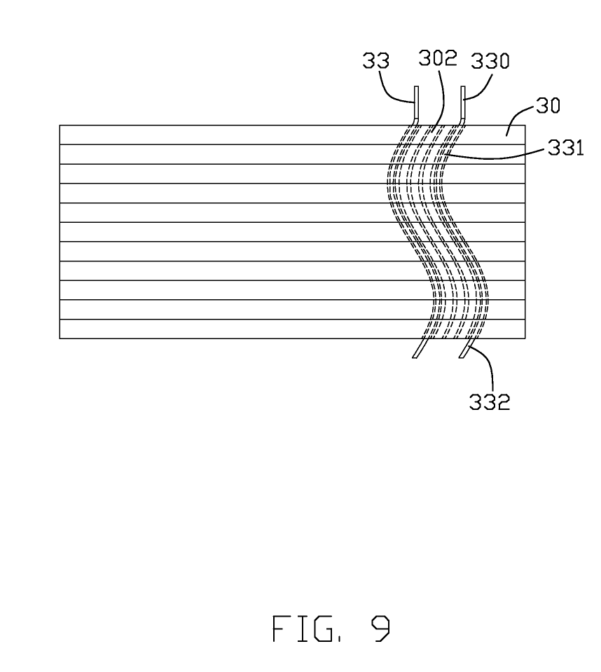

Referring to FIG. 8 and FIG. 9, the contact 33 has a helical configuration, and comprises a head portion 330 protruding upwardly beyond the positioning board 31 to contact with the IC package (no shown), a middle portion 331 located within the insulative boards 30 and a tail portion 332 extending downwardly beyond of the retaining board 32 to contact with the printed circuit board (not shown). Each insulative board 30 defines a plurality of through holes 301 for the contacts 33 passing through. Each through hole 301 of each insulative board 30 is designed according to the configuration of the contact 33, when all the insulative boards 30 are stacked together, all the through holes 301 cooperatively define a plurality of helical channels (not shown), which extend in a top-to-bottom direction and are separated with each other, the channel has a substantially same configuration as the contact 33. The contact 33 inserts into the channel of the insulative board 30 by rotating and moving downwardly, then the insulative boards 30 with the contacts 33 are together put in the cavity 20 of the base 2 from a bottom side, before the retaining board 32 is assembled to the base 2.

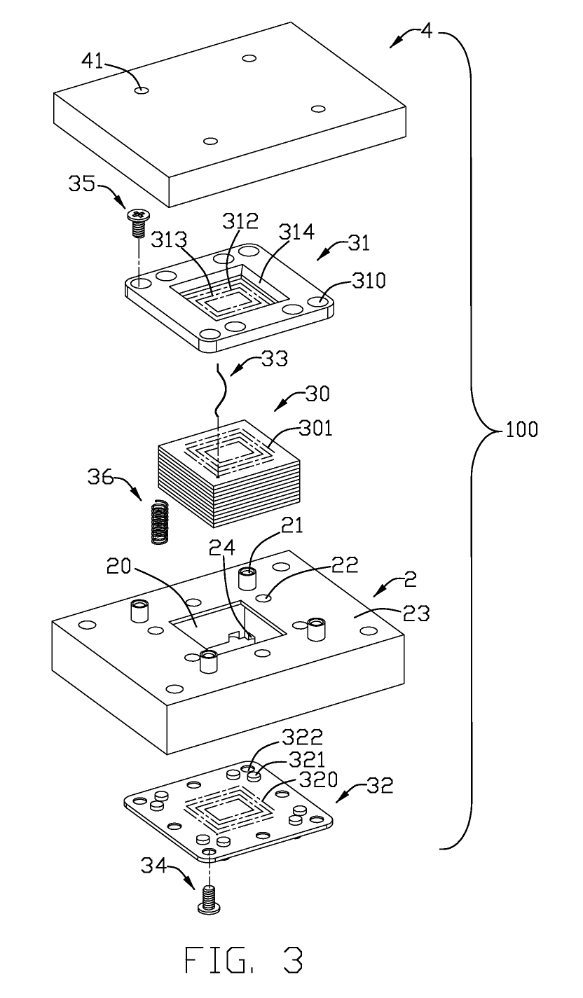

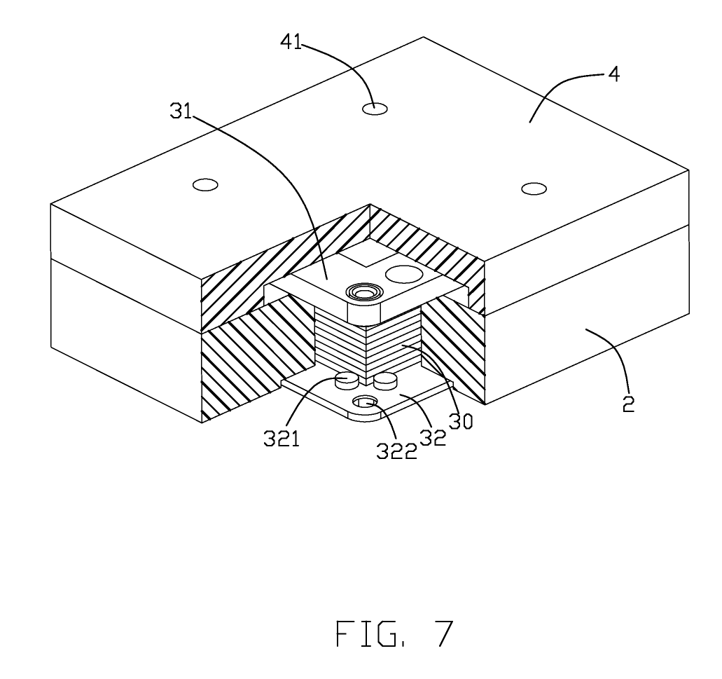

When the socket assembly 100 is assembled, the module 3 is assembled with the base 2, and the cover 4 is located upon the base 2, the contacts 33 project from the positioning board 31 and the retaining board 32, respectively. Referring to FIG. 6 and FIG. 7, and conjoined with FIG. 3, when using, the cover 4 is firstly removed, then the IC package (not shown) is put in the receiving space 314 above the bottom wall 312 of the positioning board 31, which abuts against the upper insulative board 30, then the cover 4 is retained on the base 2 by the blots (not shown) again, the cover 4 provides an evenly distributed force on the IC Package (not shown), the head portion 330 of the contact 33 contacts with the pad (not shown) of the IC package (not shown) and is compressed to deflect downwardly, since all the contacts are received in the channels by a same way, so that the deflected contacts 30 then provide uniform forces on each insulative board 30, that cause the corresponding insulative board 30 moves along with the contacts 33 in a horizontal direction, that allows the contacts 33 to further deflect, a contours line of the stacked insulative board 30 may become irregular wave shape from original linear shape. The contacts 33 can be reliably retained by the insulative boards 33 of the module 3, while also can deflect and move in the base 2 to allow the contact 33 to occur elastic deflection without shot circuit.

The helical contact 33 of the socket assembly 100 is inserted into the stacked insulative board 30 by rotational manner, the contacts 33 can have a small pitch, so that the contacts 33 can be arranged in a high density, and the socket assembly 100 can adapt to an IC package with a smaller volume and high transmission speed. When the contact 33 contacts with the IC package (not shown), the insulative boards 30 move along with the contacts 33 so that the contacts 33 are allowed to further deflect and reliably contact with the IC package (not shown).

Furthermore, the contacts 3 may not insert all of the channels, but some selected channels, according to the pads of the IC package.

However, the disclosure is illustrative only, changes may be made in detail, especially in matter of shape, size, and arrangement of parts within the principles of the invention.

What is claimed is:

1. A socket assembly comprising:
a base having a cavity;
a module receiving the contacts and mounted in the cavity of the base, the module having a plurality layers of stacked insulative boards, each insulative board defining a plurality of through holes, the through holes cooperatively defining a plurality of individual channels; and
a plurality of contacts received in the channels of the module.

2. The socket assembly as claimed in claim 1, wherein each through hole of each insulative board is designed according to a configuration of the contact, so when all the insulative boards are stacked together, the through holes of the insulative boards cooperatively define the channels, and the channel substantially has a configuration same as that of the contact.

3. The socket assembly as claimed in claim 1, wherein the base has a flange protruding from a top edge of the cavity toward a center of the cavity to block an upper insulative board of the module.

4. The socket assembly as claimed in claim 1, wherein the module further has a positioning board and a retaining board, the positioning board is assembled on a top surface of the base, the retaining board is retained on a bottom surface of the base, and the insulative boards are received in the cavity of the base and located between the positioning board and the retaining board.

5. The socket assembly as claimed in claim 4, wherein the positioning board defines a receiving space in a center thereof and a bottom wall located under the receiving space, and a plurality of contact passageways are defined on the bottom wall for receiving the contacts and corresponding to the channel.

6. The socket assembly as claimed in claim 5, wherein the positioning board is mounted on the base by a plurality of screws passing through a plurality of holes defined on the posting board and engaging with a plurality linking posts formed on the base.

7. The socket assembly as claimed in claim 4, wherein the retaining board has a plurality of contact slots corresponding to the channel for receiving the contacts, and a plurality of retaining posts extending from a top surface thereof for engaging with corresponding positioning holes defined on the base to block the insulative boards from a bottom side.

8. The socket assembly as claimed in claim 4, wherein the contact has a helical shape, and comprises a head portion protruding upwardly beyond the positioning board, a middle portion located with in the insulative board and a tail portion extending downwardly beyond the retaining board.

9. The socket assembly as claimed in claim 8, wherein the contact inserts into the channel of the module by rotating and moving downwardly

10. The socket assembly as claimed in claim 8, wherein when being pressed, the contacts deflect and bring the insulative boards moves in a horizontal direction.

11. The socket assembly as claimed in claim 8, further comprising a cover mounted upon the base and a plurality of springs disposed between the cover and the base.

12. A socket assembly, for electrically connecting IC package and a printed circuit board, comprising:
a base having a cavity;
a module mounted in the cavity of the base, the module defining a plurality helical of channels; and
a plurality of helical contacts received in the contacts.

13. The socket assembly as claimed in claim 12, wherein the contacts insert into the channels of the module by rotating and moving downwardly.

14. The socket assembly as claimed in claim 13, wherein the module comprises a plurality of stacked insulative boards, each insulative board defines a plurality of through holes, and all the through holes cooperatively defining the channels.

15. The socket assembly as claimed in claim 14, wherein the insulative boards can move in a horizontal direction when being forced by the contacts, which are pressed by the IC package.
